(19) United States
(12) Patent Application Publication
(10) Pub. No.: US 2022/0324045 A1
(43) Pub. Date: Oct. 13, 2022

(54) ELECTRICAL DISCHARGE PROCESS AND APPARATUS FOR MACHINING ELONGATED WORKPIECES

(71) Applicant: NUOVO PIGNONE TECNOLOGIE - S.R.L., Florence (IT)

(72) Inventors: Massimo ARCIONI, Florence (IT); Morando BESSI, Florence (IT); Diego GATTOLI, Florence (IT)

(21) Appl. No.: 17/753,343

(22) PCT Filed: Aug. 31, 2020
(86) PCT No.: PCT/EP2020/025391

§ 371 Date: Feb. 28, 2022

(30) Foreign Application Priority Data
Sep. 6, 2019 (IT) 10219000015773

(51) Int. Cl. B23H 9/00; B23H 11/00; B23H 7/28

(52) U.S. Cl. CPC B23H 9/005; B23H 11/003; B23H 7/28; B23H 2400/10

(57) ABSTRACT

An apparatus for electrical discharge machining process is disclosed. The apparatus comprises adjustable supports, up-on which an elongated workpiece to be machined can be placed and rotated. The adjustable support allows to adjust the position of the workpiece with respect to a base plate. The apparatus further comprises a rotating member, adapted to grip one end of the elongated workpiece to be machined and rotate it around its longitudinal axis. Also disclosed are a method for machining rotor and a monolithic shaft-impeller rotor.

### TECHNICAL FIELD

The present disclosure concerns apparatus configured to perform an electrical discharge machining process, operating methods thereof and an integral centrifugal compressor rotor, indented for allowing machining of particularly long and cumbersome elements members, wherein low machining tolerances are required.

### BACKGROUND ART

The Die Sinking electrical discharge machining process (also known as “Die sinking EDM” process) is a manufacturing process based on spark machining, whereby a desired shape of a metallic piece is obtained by using electrical discharges, i.e. sparks.

More in detail, the material is removed from the workpiece by a series of rapidly recurring current discharges between two electrodes, which are separated by a dielectric liquid, into which the workpiece to be machined is immersed. The electrodes are subject also to an appropriate electric voltage. The tool electrode is then put in electric contact with the workpiece to be machined.

Usually, one of the electrodes is called the tool-electrode, or simply the “tool” or “electrode”, while the other is called the workpiece-electrode, or “workpiece”.

As it can be easily appreciated, the process is carried out without a contact between the tool and the workpiece. In fact, when an appropriate voltage, which depends on the dielectric liquid used, between the two electrodes is increased upon a predefined threshold, the intensity of the electric field in the volume between the electrodes becomes greater than the strength of the dielectric, which breaks down, allowing current to flow between the two electrodes. As a result, material is removed from the electrodes. Then, once the current is interrupted, new liquid dielectric is usually conveyed into the inter-electrode volume (or between the tool-electrode and the workpiece to be machined), enabling the solid particles to be carried away and the insulating properties of the dielectric to be restored. In this connection, to ease this restoring process and speeding up the process, the dielectric liquid is moved by causing some turbulence of the same.

The Die Sinking EDM process is usually applied for particularly difficult machining operations, wherein, for instance, obtaining complicated channels or shaping complex parts is required, which could not be achieved with the standard machining systems, based, for instance, on mechanical removal of the material, such as milling, drilling and the like.

Currently the Die Sinking EDM process is applied to machine the impellers of disk-shaped shaft-impeller rotors. The impellers are disk-shaped mechanical elements, which are usually mechanically coupled with a rotor-shaft, having lateral sickle-shaped channels. Such channels have so the called inducer side, namely the opening in which the gas enters into the impeller, and the exducer side, which is the opening from which the gas comes out from the impeller itself, and are intended for the passage of gas in centrifugal compressor. Said channels have to be machined with high precision, so that they can form also the blades between any two of them.

In particular, said impellers, which, as said above, are disk-shaped, are easily machined by Die Sinking EDM process, as, due to their relatively small size, can be immersed in a container or a tank filled up with dielectric liquid. The sickle-shaped channels are thus made by suitable sickle-shaped electrodes, with the appropriate size, capable of easily penetrating inside the channel while it is being made.

At present, however, increasingly higher performances are required for centrifugal compressors and, consequently, for the aforementioned shaft-impeller rotors. In particular, when installed in gas turbines, said shaft-impeller rotors are subjected to rotation speeds up to 30.000 RPM. This entails considerable mechanical stresses and strains on the impellers.

It has been found that the use of monolithic shaft-impeller rotors, wherein impellers are not coupled by means of flanges and/or other mechanical members but the impellers and the shaft are made of a single piece, have improved mechanical performances and allow the achievement of the desired performances.

As mentioned above, one of the requirements for applying the Die Sinking EDM machining process is that the workpiece to be machined has to be completely immersed in the dielectric liquid. Hence, containers to be filled with a dielectric liquid have to be used, capable of containing the entire workpiece to be machined, in order for it to be completely immersed in said dielectric liquid, before carrying out the machining process.

This entails that for cumbersome parts, the application of the machining technology described above is troublesome. More specifically, in the case of a monolithic shaft-impeller rotor, which is usually more than one meter long, the arrangement of the same in a suitable container to house the same in a vertical arrangement, cannot be really functional and convenient.

Also, in order to achieve the required mentioned performances, the shaft-impeller rotor has to be realized with low machining tolerances, particularly as regard the minimization of the run-out. More specifically, it is required that the shaft-impeller rotor has a high degree of coaxiality. To this end, during the Die Sink EDM machining process of a monolithic shaft-impeller rotor, the latter has necessarily to undergo to partial rotation before the machining of any single channel. This operating step has to be carried out with high precision, for preventing the above-mentioned required run-out. It is very complicated, given the required tolerance necessary to this application, obtaining and maintaining the coaxiality of the arranged vertically shaft-impeller rotor while it is rotated.

It's clear that the known equipment has a negative impact both for the high operation costs, as well as for the operating complications, due to the low machining tolerances required.

Accordingly, an improved apparatus and an operating method thereof would be welcomed in the technology. More in general, it would be desirable to provide a machining apparatus or equipment capable of allowing the machining of long monolithic workpieces, such as a monolithic shaft-impeller rotor, by means of the Die Sinking electrical discharge machining process, in an economically convenient way.

### SUMMARY

In one aspect, the subject matter disclosed herein is directed to an apparatus for Die Sinking electrical discharge machining process, particularly for machining a monolithic shaft-impeller rotor, which result cumbersome and heavy, such that their machining is not usually easy when a high precision of the machining is required. The apparatus comprises a support frame comprising a base plate and a machining head unit, having an electrode for performing the electrical discharge machining process. The apparatus has adjustable supports, upon which rotor is placed and rotated around a specific axis with high precision. The height of said adjustable support can be adjustable. The apparatus further comprises a rotating member adapted to grip one of the ends of a monolithic shaft-impeller rotor to be machined and rotate it around its longitudinal axis.

In another aspect, disclosed herein is a method for machining a monolithic shaft-impeller rotor by an improved Die Sinking electrical discharge machining process. The method includes several steps, which unless otherwise indicated, can be performed in any suitable order: arranging an elongated workpiece of at least around 0.80 meters rotor is on bearings of adjustable supports of a Die Sinking electrical discharge machine; inserting one of the ends of the monolithic shaft-impeller rotor in a housing of a collar of a rotating member; and checking that a position of the monolithic shaft-impeller rotor is suitable to carry out the Die Sinking electrical discharge machining process by means of an electrode, while rotating about its own symmetry axis with a very reduced run-out. While carrying out the machining method, the mon-olithic shaft-impeller rotor is rotated about its own axis by means of the rotating member. The rotation is facilitated by the bearings of the supports. The monolithic shaft-impeller rotor is arranged in such a way that the low run-out of its rotation allow the machining of channels on the impeller with high precision.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a perspective view of an embodiment of apparatus for a new electrical discharge machining process;

FIG. 2 illustrates a second perspective view of the apparatus of FIG. 1;

FIG. 3 illustrates a side view of the apparatus of FIG. 1;

FIG. 4 illustrates a monolithic shaft-impeller rotor to be machined by the apparatus of FIG. 1;

FIG. 5 illustrates an embodiment of an adjustable supports of the apparatus of FIG. 1;

FIG. 6 illustrates a rotating table of the apparatus of FIG. 1;

FIG. 7 illustrates a collar for housing and gripping an end of a monolithic shaft-impeller rotor of the rotating table of FIG. 6;

FIG. 8 illustrates an embodiment of a machining head unit of the apparatus of FIG. 1;

FIG. 9 illustrates an electrode installed on the machining head unit of FIG. 8, intended for carrying out the Die Sinking electrical discharge machining process;

FIG. 10 illustrates an adjustment operation for positioning a monolithic shaft-impeller rotor to be machined;

FIG. 11 illustrates a further operation for positioning a monolithic shaft-impeller rotor to be machined; and

FIG. 12 illustrates a flowchart of a method for machining a monolithic shaft-impeller rotor.

In the various figures, similar parts will be indicated by the same reference numbers.

### DETAILED DESCRIPTION OF EMBODIMENTS

According to one aspect, the present subject matter is directed to an improved apparatus configured to process elongated workpieces by Die Sinking electrical discharge machining process, wherein low machining tolerances in terms of run-out are required. The new, improved apparatus is uniquely designed to maintain axial symmetry of an elongated workpiece during the machining process.

The apparatus is capable of machining elongated workpieces, such as a monolithic shaft-impeller rotors, or the like, which may be horizontally arranged, relative to a substantially planar surface that supports the apparatus, so as to allow complete immersion of the elongated workpiece within a dielectric liquid, for the elongated workpiece to be processed (e.g., machined, fabricated, made, etc.) by an improved Die Sinking electrical discharge machining process. Referring to Cartesian axes XYZ, the elongated workpiece has a longitudinal main axis, which can be considered aligned to the X axis. The elongated workpiece can rotate around such X axis while machined. In operation, the elongated workpiece rotates also around the main axis, with respect to which a low roll-off has to be achieved. Also, the electrode can be moved with respect to the elongated workpiece itself, in order to allow very low machining tolerances and perform complicated machining. The electrode can move in the space surrounding the workpiece also translating along the Z axis, which is the axis vertical with respect to the plane the apparatus is places, and the Y axis, perpendicular with respect to the other two axes.

Therefore, by means of a rotation of the elongated workpiece around its main axis while the Die Sinking electrical discharge machining process is carried out, and by a control of the positioning of the elongated workpiece to accomplish a low run-off rotation effect, it is possible to obtain a precise processing and, at the same time a considerable saving of dielectric liquid, even if particularly bulky workpieces are handled. Indeed, the Die Sinking electrical discharge machining process requires that a piece to be machined is completely immersed in a dielectric liquid. In an arrangement for reducing the volume of a containment tank, the elongated workpiece can be arranged horizontally. This implies that a specific control of the rotation of the workpiece around the main axis is carried out.

To accomplish the above results, the apparatus is equipped with supports that can be adjusted to support and fine adjust elongated workpiece in order for it to be rotated around its main axis. Also, means for rotating the workpiece during the machining operations are provided, which keep firmly the workpiece itself in position while rotating. In this way, the elongated workpiece is smoothly rotated around the main axis and it is properly supported to reduce any possible run-off

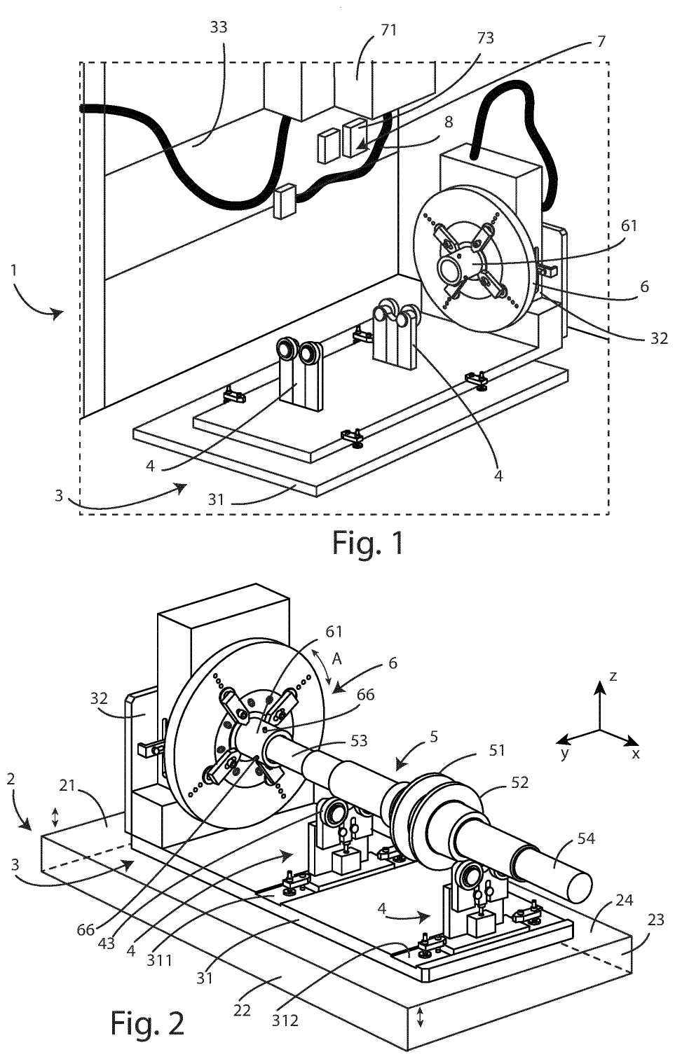

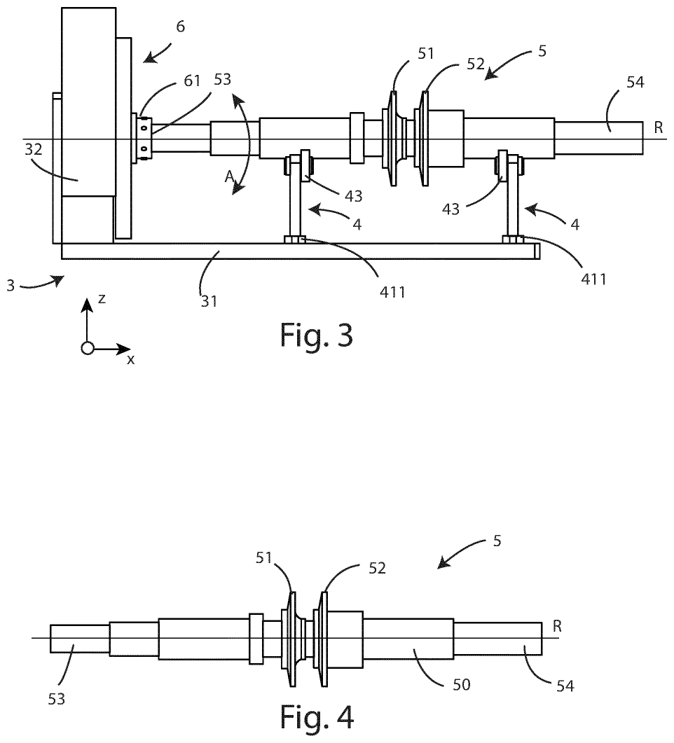

Referring now to the drawings, FIGS. 1, 2, 3, 4, 5, 6, 7, 8 and 9 shows an embodiment of improved apparatus for Die Sinking electrical discharge machining (EDM) process, which is wholly indicated with the reference number 1. The apparatus 1 generally comprises a tank 2, a support frame 3, having a base plate 31, adjustable supports 4, placed on said base plate 31, adapted to support the workpiece to be machined, such as a monolithic shaft-impeller rotor 5, a rotating table 6, for rotating the workpiece during the machining processes, and a machining head 7, for holding an electrode 8, to carry out the Die sinking EDM processing. Unlike apparatuses or equipment according to the prior art, the apparatus 1 provides that the cooperation of the rotating table 6 and the adjustable supports 4 allow a control of the rotation of an elongated workpiece around its main axis while machined with a reduced run-out. Also, unlike prior art machines, the apparatus 1, due to the shape of 2, allows a remarkable saving of dielectric liquid.

The different parts of the apparatus 1 will be disclosed in detailed in the following.

The tank 2 is adapted to contain the dielectric liquid, in which the workpiece to be machined is submerged during the machining process. In the present embodiment, the tank 2 is made of four vertical bulkheads 21, 22, 23 and 24 vertically movable. More specifically, taking into consideration the three Cartesian axes XYZ, where the Z axis is perpendicular with respect to the base plate 31, along the X axis is aligned the main axis R of the monolithic shaft-impeller rotor 5, which in the case at issue is the symmetry axis and it is the axis around which the workpiece has to be rotated with a low run-off, as better explained below, and the Y axis is perpendicular to the other two X-Z axes. Therefore, said bulkheads 21, 22, 23 and 24 can be raised and lowered along said Z axis. Also, said bulkheads 21, 22, 23 and 24 can be raised as much as necessary to allow the dielectric liquid to be poured in the tank 2 to completely cover the workpiece 5 to be machined.

The tank 2 can be also realized in other ways, provided that the containment of the dielectric liquid is possible, so as to completely submerge the workpiece 5 to be machined in a substantially horizontal position.

The support frame 3 comprises said base plate 31, placed at the bottom, to support the workpiece to be machined, which has a first 311 and a second 312 positioning guides, whose function will be better defined in the following. Still referring to the above-mentioned Cartesian axes, said first 311 and second 312 positioning guides are parallel from each other and arranged along the direction of the Y axis.

The support frame 3 also comprises a supporting block 32, placed at an edge of the base plate 31 and arranged vertically with respect to the latter. The support frame 3 comprises also beams 33, arranged at the upper part, provided with guides (not shown in the figures) to allow the movement in the space of the machining head unit 7, as better explained below.

In some embodiments, other movement systems or solutions or variants can be foreseen, as it will be better discussed below, then the beams 33 and the support frame 3 can have a different configuration.

As mentioned above, the apparatus 1 disclosed is configured to machine elongated workpieces of at least 0.8 meters. The apparatus 1 can be used for various types of components and parts of turbomachines, and in one embodiment is configured to machine (or produce) an elongated, monolithic shaft-impeller rotor, such as the one shown in FIG. 4. This rotor may be configured for use in a turbomachine, such as a compressor. The compressor may be a centrifugal compressor.

In particular, the elongated monolithic shaft-impeller rotor 5 shown in FIG. 4 has a rotor shaft 50, two impellers 51 and 52, substantially positioned in the center of the rotor 5 and facing each other. Said monolithic shaft-impeller rotor 5 also has two ends 53 and 54. Just by way of example of typical minimum sizes of an elongated monolithic shaft-impeller rotor 5, that can be fabricated/produced using the new electric discharge machine and process described herein, can have a length of 1018 mm, while impellers may have a radius of 187 mm. It is apparent that the measurements are shown here only as an example and have not to be considered limiting with respect of the scope of protection, as different dimensions can be provided.

In general, the apparatus 1 is conveniently used for machining elongated workpieces at least 800 millimeters long, up to even 2000 or more millimeters. In fact, monolithic shaft-impeller rotors of the above indicated length, being integrally formed in one piece, having disk-shaped impellers extending radially outward from the longitudinal main axis, have improved mechanical performances with respect to those having the impellers coupled with the shaft, because in the formers the impellers can subject to increased mechanical stresses.

The apparatus 1 may be configured to include two adjustable supports 4.

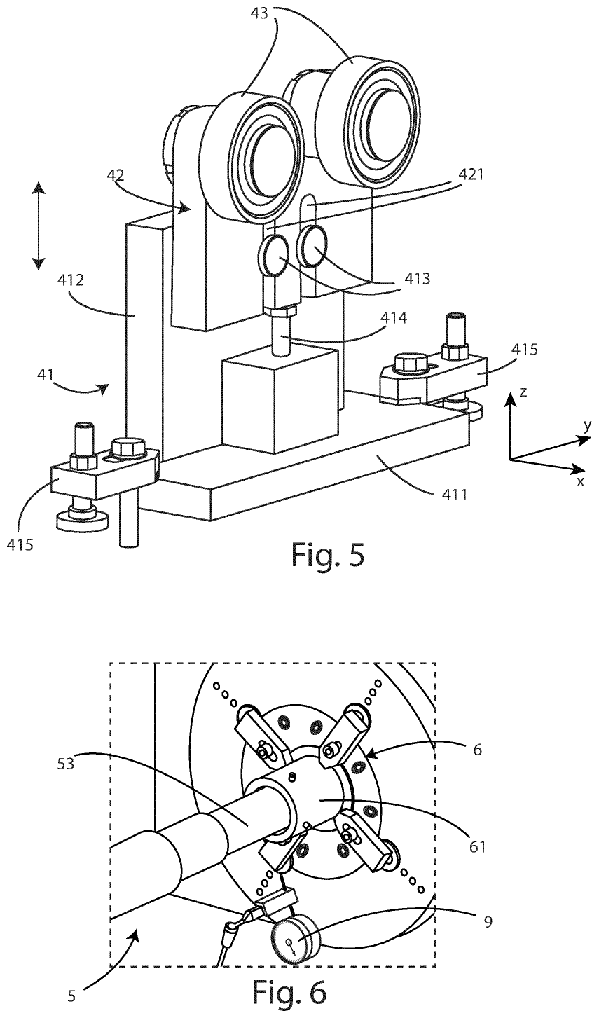

Each of the two adjustable supports 4 has (see FIG. 5) a main body 41. Each main body 41 has a plate 411 and a vertical portion 412. The plate 411 is slidably engaged in one of the first 311 or second 312 positioning guides, so as to be fixed to the upper surface of said base plate 31. In particular, such arrangement allows an optimal alignment of the supports 4, which are intended to allow the monolithic shaft-impeller rotor 5 to be positioned horizontally. Equipment according to the prior art are not equipped with adjustable vertical support capable of allowing, whenever necessary, the rotation of the rotor 5, and in general bulky the elongated element to be machined, around its main axis R.

The vertical portion 412 is perpendicularly arranged with respect to said plate 411 and thence with respect to said base plate 31. Said main body 41 of said adjustable support 4 also includes a pair of pins 413, fixed to a face of said vertical portion 412, and an adjustment grain 414, whose function will be better explained in the following.

Moreover, said main body 41 of each of said adjustable supports 4 also comprises appropriately adjustable fixing members 415 for fixing the plate 411 to the base plate 31 along the respective first 311 or second 312 positioning guides, so as to adjust the position of each adjustable support 4 along the Y axis.

Each of said adjustable supports 4 also comprises a slider 42, which has two guiding channels 421, arranged parallel to each other, along the Z axis direction, namely perpendicular with respect to the base plate 31. Each one of said pins 413 is slidably inserted in a respective guiding channel 421. In this way, the slider 42 is capable of moving vertically with respect to said main body 41, guided by said pins 413. The provision of two parallel guiding channels 421 allows the slider to rigidly translate vertically (namely perpendicularly with respect to the base plate 31) without undergoing any rotation, to ensure an easy adjustment of the positioning of the vertical supports 4 and then of the monolithic shaft-impeller rotor 5 when positioned upon said adjustable supports 4.

The structure of the adjustable supports 4 disclosed above allows a fine alignment of the main axis of the monolithic shaft-impeller rotor 5 (or any other type of elongated workpiece) in a desired position, to perform the machining process required. Other structures could be realized capable of allowing a fine adjustment of the vertical and horizontal position of elongated workpiece, to properly align the main axis R of the same.

The adjustable support 4 also comprises a pair of bearings 43, pivoted on said slider 42 and arranged side by side, so as to be able to support the elongated workpiece to be machined. In particular, in case of the monolithic shaft-impeller rotor 5, each of said two adjustable supports 4 is arranged so as to support said rotor 5 in a substantially intermediate point between each of the ends 53 and 54 and the respectively closer impeller 51 or 52, as it can be seen in FIG. 2. The bearings 43 allow the correct and smooth rotation of the rotor 5 to be machined along its own main axis, namely the first rotational axis A, around the axis of symmetry of the workpiece referred to with letter R, which, in the embodiment shown, is aligned to the X axis. As can be seen, by means of said fixing members 415 it is possible to adjust the position of each adjustable support 4 with respect to the base plate 31. Furthermore, by acting on the adjustment grain 414 it is also possible to accurately raise or lower the slider 42, and consequently the bearings 43, on which, as mentioned, the monolithic shaft-impeller rotor 5 is arranged before being machined.

Each pair of bearings 43, being arranged at the top of a respective adjustable support 4, can house and bear the weight of the monolithic shaft-impeller rotor 5 arranged on the two properly adjustable supports 4 and, at the same time, the rotor 5 can be smoothly rotated around its main axis, with a low run-off.

In the embodiment shown, the two adjustable supports 4 are arranged aligned along the X axis, being them movable respectively along said first 311 and second 312 positioning guides, with respect to the rotating table 6 and in such a way as to allow the support in two intermediate points of the shaft 5 or the workpiece in general, so as to allow an optimal support and positioning during the processing steps.

More specifically, the two adjustable supports 4 are fixed to said base plate 31 so that when the monolithic shaft-impeller rotor 5 to be machined is placed on them, it is supported in two substantially and preferably symmetrical intermediate positions.

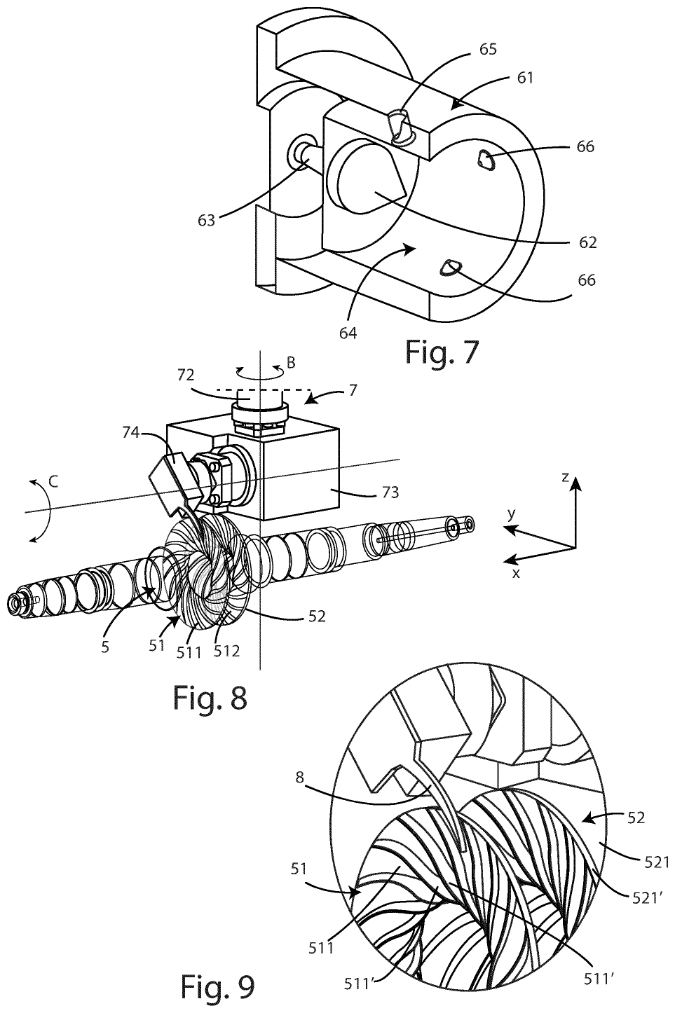

The rotating table 6 has the function of keeping the rotor 5 in position and rotate the same around its main axis R during the machining steps. The rotating table 6 is arranged and fixed on said supporting block 32. Also, referring to FIGS. 6 and 7, it can be seen that said rotating table 6 has a collar 61, placed on the center of one of the faces of said rotating table 6, wherein said collar 61 is adapted to ease the correct assembly of the rotor 5 and to ensure the coaxial rotation of the monolithic shaft-impeller rotor 5 caused by said rotating table 6, namely a rotation around the main axis of the rotor 5 with a low run-off.

The collar 61 has at its center a housing 64, intended to house an end 53 of the rotor 5. Within said housing 64 of the collar 61, a centering tip 62 is installed, mounted on a conical seat (not shown in the figures) and pulled by a pulling screw 63. By means of the centering tip 62, accurately centering the rotor shaft 5 is possible, allowing the rotation with respect to the main axis R (the longitudinal axis) of the monolithic shaft-impeller rotor 5 or of the workpiece in general.

Also, within the collar 61 there is a flanged bush 65 comprising threaded grains 66 for gripping the end 53 of the monolithic shaft-impeller rotor 5 after being inserted in said housing 64. The flanged bush 65 and the threaded grains 66 allow a secure gripping of the monolithic shaft-impeller rotor 5, necessary also for rotating the same around the main axis R, avoiding it to slide or shift.

The rotating table 6 is rotatable around said rotation axis A, by means of suitable drive units, such as an electric motor or the like, not shown in the figures. In the embodiment shown, the rotation axis A is aligned (parallel) to the main axis R of the rotor 5.

In some embodiments, the rotating table 6 can be any rotating member capable of gripping and rotating said monolithic shaft-impeller rotor 5, while the latter is placed on the adjustable supports 4.

By means of the flanged bush 65 and its threaded grains 66 is possible to transmit the rotation motion to said rotor shaft 5 by friction, allowing the stepwise rotations thereof during the processing steps, as better explained below.

The machining head unit 7, shown also in FIGS. 8 and 9 of the apparatus 1 according to this embodiment, comprises a carrier 71, movable in this embodiment, along guides placed on the beams 33 of said support frame 3 (the guides are not shown in the figures), so that said carrier 71 can move on a X-Y plane above said monolithic shaft-impeller rotor 5 to be machined.

Said machining head unit 7 comprises a vertical support 72, which is telescopic, and it is arranged along the Z axis. A first end of said vertical support 72 is rotatably coupled with said carrier 71. Also, said machining head unit 7 comprises a head 73, rotatably coupled with the second end of said vertical support 72, around a second rotational axis B.

By the above arrangement, the head 73 can be moved in the space along the three Cartesian degrees of freedom (X, Y and Z axes), and one rotational degrees of freedom, around said secondo rotational axis B, which, in this embodiment, is parallel to said Z axis.

An electrode holder 74, on which the electrode 8 for carrying out the Die sinking EDM process can be removably coupled, is in its turn rotatably coupled with said head 73, along a third rotational axis C. The third rotational axis C is arranged perpendicular with respect to the Z axis.

By the above arrangement, the electrode holder 74 can be moved in the space along the same four degrees of freedom of the head 73, plus the additional rotational degree of freedom around the third rotational axis C. Therefore, the electrode holder 74 can be moved in the space surrounding the monolithic shaft-impeller rotor 5 to be machined (or any elongated workpiece) over five degrees of freedom. Considering also that the shaft-impeller rotor 5 can stepwise rotate around the first rotational axis A, as better explained above, the relative movement between the electrode holder 74 and the shaft-impeller rotor 5 is characterized, in the present embodiment, by a total of six degrees of freedom, namely three translational degrees of freedom (along the three Cartesian axes), and three rotational degrees of freedom (around the rotational axes A, B and C). Thus, the apparatus 1 is endowed with a remarkable operational flexibility. As said, in the present embodiment shown in the figures, the rotational A axis coincides with the X axis, which, in use, the main axis R of the elongated work-piece is aligned to; while the rotational B axis coincides with the Y axis.

In yet further embodiments other systems for moving a the electrode holder 74, and hence the electrode 8, in the space surrounding the shaft impeller rotor 5 can be provided, such as, by way of example, a robotic arm, with one or more wrists, capable of moving and orienting the electrode in the space along several translational and rotational degrees of freedoms. In this way, the electrode 8 can reach any point of the surface of the monolithic shaft-impeller rotor 5, for carrying out the Die Sink EDM process in any part of the workpiece.

As already mentioned above, the electrode 8 is sickle-shaped and it can be removably coupled with the electrode holder 74, to change the size of the same, depending on the size of the channel to be realized and machined.

FIG. 9 shows how the electrode 8 enters in the lateral surface of the impeller 51, realizing a sickle-shaped channel 511 (the electrode can realize the channels 521 of the impeller 52), intended to realize also the blades 511′ (or 521′ of the impeller 52) for a centrifugal compressor.

As it can be easily appreciated, machining a channel like that shown in said FIG. 9 can be complicated if not almost impossible with conventional systems based on mechanical removal of material, namely by milling or drilling machining processes.

In some embodiments other structures can be foreseen to move in the space the head 72, for it to easily reach any part of the monolithic shaft-impeller rotor 5, and in particular the lateral surfaces of the impellers 51 or 52 or any other part of the rotor, so to realize the inducer sides, namely the opening in which the gas enters into the impeller, and the exducer sides, which is the opening from which the gas comes out from the impeller itself, of the channels 511 and 512. As mentioned above and still by way of example, the head 72 can be installed on an articulated anthropomorphic arm, such that it is provided with an even increased number of degrees of freedom for orienting said head 72 in the space.

The operation of the apparatus 1 for Die Sinking electrical discharge machining process described above is as follows.

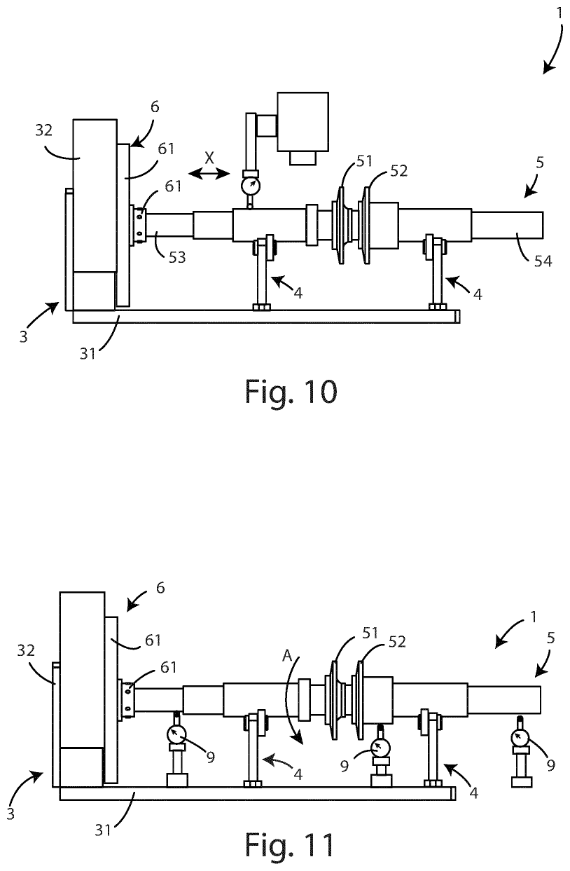

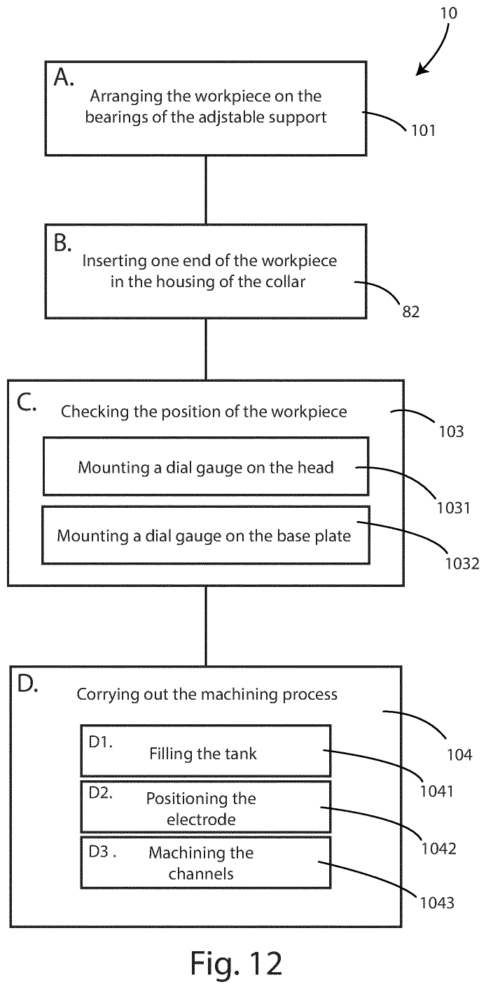

Referring to FIGS. 10, 11 and 12, as a first operating step, once the apparatus 1 has been assembled, the end 53 of the monolithic shaft-impeller rotor 5 in arranged on the adjustable supports 4 (FIG. 12, step 101 of the flowchart 10) and inserted in housing 64 of the collar 61 (FIG. 12, step 102). The end 53 is pivoted on the centering tip 62, pulled by the screw 63.

Then, the main axis R of the monolithic shaft-impeller rotor 5 has to be correctly positioned along a direction perpendicular with respect to the center of the rotating table 6, as illustrated in FIG. 12, step 103. The alignment check is important to ensure the planarity and concentricity of the entire monolithic shaft-impeller rotor 5 before it is machined to carry out the realization of the channels 511 and 521 respectively of the impellers 51 and 52 by the Die Sinking EDM technology. The alignment check is actually carried out by means of one or more dial gauges 9.

More specifically, by the dial gauges 9, basically two checks are performed:
in a first check, as illustrated in FIG. 12, step 1031, a dial gauge 9 is mounted on the head 73 and is scrolled along the X axis to check that the entire monolithic shaft-impeller rotor 5 is parallel to the X axis, namely that the longitudinal rotation axis R of the monolithic shaft-impeller rotor 5 is aligned with the X axis (see also FIG. 10); and
in a second check, as illustrated in FIG. 12, step 1032, the monolithic shaft-impeller rotor 5 concentricity is checked in several positions by mounting a dial gauge 9 on the base plate 31 and rotating the monolithic shaft-impeller rotor 5 (or the work-piece to be machined) through the rotation of the rotating table 6 (see also FIG. 11) over the four bearings 43 of the two adjustable supports 4.

The adjustable supports 4 keep the monolithic shaft-impeller rotor 5 main axis R properly aligned to the X axis, being the rotor 5 adjustable on two axes (Y,Z). More specifically, each adjustable supports 4 can be positioned along the respective first 311 or second 312 positioning guides of said base plate 31, aligned along said Y axis, while, for adjusting the height of the adjustable supports 4, and then of the monolithic shaft-impeller rotor 5 with respect of the base plate 31, namely along the Z axis, the adjustment grain 414 can be rotated, so that the slider 42 can scroll over the vertical portion 412.

Once the rotor 5 is positioned, so as reduce any possible run-off during its possible rotation, a workpiece-electrode is connected with it and the machining process can start, as illustrated in FIG. 12, step 104. Then, the four bulkheads 21, 22, 23 and 24 are raised and the dielectric liquid is introduced in the container formed by said four bulkheads 21, 22, 23 and 24, in order to cover the monolithic shaft-impeller rotor 5 (see FIG. 12, step 1041).

In this configuration, after that all the positioning adjustments have been made, the electrode 8 reaches the side of the impellers 51 or 52, for carrying out the Die Sinking EDM process, realizing the channels 511 or 51, as illustrated in FIG. 12, step 1042.

As it can be appreciated, the electrode 8 can reach any point of the impellers 51 or 52, changing its position and orientation by means of the machining head unit 7, and particularly the carrier 71, the vertical support 72 and by rotating the electrode holder 74 around the third rotational axis C. Also, the monolithic shaft-impeller rotor 5 is stepwise rotated along the first rotational axis A, by means of the rotating table 6, so that the electrode 8 can easily reach all the circumferential edge of each impeller 51 or 52, thus realizing the channels 511 or 512, as illustrated in FIG. 12, step 1043.

While aspects of the invention have been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

For instance, while in the above disclosed embodiments an apparatus for Die Siking EDM process has been described, which is aimed at reducing the run-out during the rotation around its main axis, those skilled in the art will understand that the arrangement disclosed can be used in different systems, in which a reduced run-out may be required.

Reference have been be made in detail to embodiments of the disclosure, one or more examples of which have been illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments, the articles “a”, “an”, “the”, and “said” are intended to mean that there are one or more of the elements. The terms “comprising”, “including”, and “having” are intended to be inclusive and mean that there may be additional elements other than the listed elements.

1-19.

20. An apparatus configured to perform a die sinking electrical discharge machining process, particularly for machining workpieces, particularly elongated workpiece, wherein the elongated workpiece has a first and a second end, a longitudinal axis, the apparatus comprising:
a tank configured to contain a dielectric fluid,
a support frame comprising a base plate and
a machining head unit, equipped with an electrode that is configured to perform the electrical discharge machining process on the elongated workpiece,
wherein
the apparatus comprises:
at least one adjustable support, upon which the elongated workpiece to be machined can be placed and rotated,
wherein the height of the adjustable support is adjustable, so as to adjust the position of the elongated workpiece with respect to a first axis, perpendicular with respect to the base plate, and
in that the apparatus further comprises a rotating member adapted to grip one of the ends of the elongated workpiece to be machined and rotate it around its main axis.

21. The apparatus according to claim 20, wherein the adjustable support is adjustably arranged on the base plate and is configured to adjust its position with respect to a second axis, perpendicular with respect to the first axis.

22. The apparatus according to claim 20,
wherein the base plate has one or more positioning guide arranged along the second axis, and
wherein each one of the adjustable supports comprises
a main body having a plate, slidably engaged in one of the positioning guides, and
adjustable fixing members for fixing the plate to the base plate along the respective positioning guide.

23. The apparatus according to claim 20, wherein the base plate has two positioning guides, parallel with each other, and corresponding two adjustable supports, each one engaged with a respective positioning guide.

24. The apparatus according to claim 22,
wherein the main body of the adjustable support comprises a vertical portion, perpendicularly arranged with respect to the base plate, and
wherein the adjustable support comprises a slider slidably coupled with the vertical portion, so as to move along a perpendicular direction with respect to the base plate.

25. The apparatus according to claim 24, wherein the vertical portion comprises
at least a pair of pins, fixed to a face of the vertical portion, and
an adjustment grain, and
the slider has two guiding channels, parallel to each other, along the second axis, perpendicular with respect to the base plate,
wherein each one of the pins is inserted in a respective guiding channel,
so that by acting on the adjustment grain, the position of the slider can be adjusted with respect to the main body, along the direction of the first axis, perpendicular with respect to the base plate.

26. The apparatus according to claim 25, wherein the adjustable support comprises at least a pair of bearings, pivoted on the slider and arranged side by side, wherein the elongated workpiece is intended to be supported by the bearings and wherein the bearing is adapted to allow the rotation of the elongated workpiece around its main axis upon the rotation by means of the rotating table.

27. The apparatus according to claim 20, wherein the rotating table comprises a collar, having
a housing, in which one of the first or the second end of the elongated workpiece to be machined can be inserted, and
a centering tip, arranged within the housing, on which the first or the second end of the elongated workpiece is pivoted to rotate.

28. The apparatus according to claim 27, wherein the rotating table comprises
a pulling screw, arranged within the collar and functionally coupled with the centering tip for pulling it against the end of the elongated work-piece to be machined inserted in the collar, and
a flanged bush comprising threaded grains for gripping the end elongated workpiece to be machined inserted in the collar.

29. The apparatus according to claim 20, wherein the machining head unit comprises
a head, arranged for move in the space along three Cartesian axes and to rotate along at least one rotational axis, and
an electrode holder, on which the electrode for carrying out the electrical discharge machining process can be removably coupled, wherein the electrode holder is rotatably coupled with the head, so as to rotate along a rotational axis.

30. The apparatus according to claim 29, wherein the support frame comprises beams, arranged provided with guides,
wherein the machining head unit comprises
a carrier engaged with the guides of the beams, so as to move the head above the elongated workpiece, and
a vertical support, arranged perpendicular with respect to the base plate, wherein a first end of the vertical support is rotatably coupled with the carrier and a second end of the vertical support is rotatably coupled with the head.

31. The apparatus according to claim 20, comprising a tank, adapted to contain a dielectric liquid, in which the elongated workpiece can be submerged during the processing.

32. The apparatus according to claim 31, wherein the tank is made of four bulkheads, each one vertically movable.

33. The apparatus according to claim 20, wherein it is configured to the Die Sinking electrical discharge machining process for elongated workpieces having a length of at least 800 millimeters.

34. The apparatus according to claim 20, wherein said the elongated workpiece is a monolithic shaft impeller rotor.

35. The apparatus according to claim 34, wherein the monolithic shaft impeller rotor is for a centrifugal compressor.

36. A method for machining a monolithic shaft-impeller rotor and the like by Die Sinking electrical discharge machining process, wherein the monolithic shaft-impeller rotor has a first and a second end, a main axis and at least one impeller, and wherein an apparatus comprises a machining head unit, equipped with an electrode that is configured to perform the electrical dis-charge machining process on the monolithic shaft-impeller rotor,
wherein
the apparatus comprises least one adjustable support, upon which the monolithic shaft-impeller rotor to be machined can be placed and rotated, wherein the height of the adjustable support is adjustable, so as to adjust the position of the monolithic shaft-impeller rotor with respect to a first axis, perpendicular with respect to the base plate, and a rotating member adapted to grip one of the ends of the monolithic shaft-impeller rotor to be machined and rotate it around its main axis, wherein said rotating member comprises a collar, having a housing, in which one of the first or the second end of the monolithic shaft-impeller rotor to be machined can be inserted, and
in that the method comprises the following steps:
A. arranging the monolithic shaft-impeller rotor on the bearings of the at least one adjustable support;
B. inserting one of the ends of the monolithic shaft-impeller rotor in the housing of the collar;
C. checking the position of the monolithic shaft-impeller rotor, so that the rotating table rotates the monolithic shaft-impeller rotor over its rotation main axis; and,
D. carrying out the Die Sinking electrical discharge machining process by means of the electrode.

37. The method according to claim 36, wherein the checking step C comprises the following sub-steps:
C1. mounting a dial gauge on the head and scrolling the mon-olithic shaft-impeller rotor along its longitudinal axis; and/or,
C2. mounting a dial gauge on the base plate and rotating in several positions the monolithic shaft-impeller rotor over the bearings of the adjustable supports by the rotating table.

38. The method according to claim 36,
wherein the apparatus comprises a tank configured to contain a dielectric fluid,
wherein the machining head unit comprises a head, arranged for moving in the space along three Cartesian axes and rotating along at least one rotational axis, and an electrode holder, on which the electrode for carrying out the electrical discharge machining process can be removably coupled, wherein the electrode holder is rotatably coupled with the head, so as to rotate along a rotational axis, and
wherein the processing step D comprises the following sub-steps:
D1. filling the tank with a dielectric liquid;
D2. positioning the electrode by means of the head and by means of the machining head unit; and,
D3. machining sickle-shaped channels on the at least one impeller of the monolithic shaft-impeller rotor by means of the electrode.
